(19) United States
(12) Patent Application Publication
(10) Pub. No.: US 2014/0279395 A1
(43) Pub. Date: Sep. 18, 2014

(54) SYSTEM AND METHODS FOR PROVIDING LEAST COST DATA ACQUISITION FOR FINANCIAL DECISIONS

(71) Applicant: Zoot Enterprises, Inc., Bozeman, MT (US)

(72) Inventors: Peter Quinlan, Colorado Springs, CO (US); Tom Johnson, Bozeman, MT (US); Chris Nelson, Bozeman, MT (US)

(73) Assignee: Zoot Enterprises, Inc., Bozeman, MT (US)

(21) Appl. No.: 14/202,839

(22) Filed: Mar. 10, 2014

Related U.S. Application Data
(60) Provisional application No. 61/792,649, filed on Mar. 15, 2013.

(51) Int. Cl. G06Q 40/02

(52) U.S. Cl. CPC G06Q 40/025
USPC 705/38

(57) ABSTRACT

Systems and methods for providing credit decisions using the least cost necessary to access data sources. A lending institution can create custom credit decisioning rules which use only the data needed to grant or deny credit. Credit decision data sources are optimized for cost or likelihood of success to provide the lowest overall cost for the credit query. Embodiments allow for early identification of denial or approval of credit and also for identification of various credit products or packages.

### CROSS-REFERENCE TO RELATED APPLICATIONS

The present application claims priority to and incorporates herein by reference U.S. Provisional Patent Application Ser. No. 61/792,649 filed on Mar. 15, 2013.

### BACKGROUND

Many institutions evaluate data from various data sources in order to make decisions regarding credit worthiness, fraud, propensity to buy or invest. Accordingly, while this description, in places, refers to banks and lending institutions, there are many other types of persons and institutions that have use for and will use and implement this invention. For example, banks and other lending institutions must make decisions about the likelihood of a borrower to pay back the borrowed money. These decisions apply to the small, medium, and large lending options ranging from store credit to credit cards to automobile loans to home equity loans to mortgages. With each change in risk profiles, different analyses of the credit worthiness of the borrower are performed. Further, each bank or lending institution has a different risk profile that they tolerate.

Several companies exist to collect and centralize information on individuals, including those companies that collect information on credit, outstanding loans, repayment histories, and many other details, not limited to those in the financial industry. Similarly, other generally available credit risk score providers look at variable such as payment history, credit utilization, length of credit history, types of credit used (installment, revolving, consumer finance, mortgage), and recent searches to generate scores that represent individual characteristics of credit worthiness. Many companies are entering the market providing various data repositories which look at many different and newly emerging personal and risk data to calculate scores on potential fraud or malicious behavior.

Other companies exist, such as Zoot Enterprises (the assignee/patent applicant herein), which provide services to lenders, and other institutions that gather data to render a decision, to create custom decision criteria based upon the specific credit information available from various sources like the credit repositories and credit risk score providers. Each credit decision is unique, in as much as the parameters of the credit request and the individual's risk profile are unique. However, while the decisions are unique the method of coming to that decision is a well-defined business process that must also be accessible to review and for oversight. Thus, a need exists to provide credit decisions to lenders based on their business requirements for each of their lending product lines.

The basic approach for credit decisioning, or execution of a decision policy, is well known and has been disclosed and used by Zoot and others for well over a decade. Interestingly, though, none of the existing approaches allow a variety of data sources, including credit worthiness sources, to be combined in a cost-effective manner. Existing approaches simply follow a process for reviewing a fixed set of sources to determine a score. The use of each source generally incurs a cost, and for large institutions the combined costs for the variety of sources and number of data acquisition requests can be quite expensive. However, there exists no known method to optimize the data source usage to incur lower costs during the credit decision process.

A long felt need in this art relates to a cost effective approach for selecting and reviewing data from a variety of sources to provide an efficient and consistent credit or policy decision which reflects the institution's business goals yet also supports compliance to various laws and regulations that pertain to the industry.

### SUMMARY

Each loan, risk, or policy decision can be made by acquiring data from any of a variety of national and international repositories including, for example, credit files, demographic data, alternate credit data, property valuation, flood certifications, car valuations, et cetera. Because modern technology has enabled wider access to data sources by making previously difficult to access written records available digitally, lending institutions are using more data to provide a richer context to their financial decisions. The newly available combination of fraud, credit, collateral, institutional, and other compliance devices provides the opportunity to categorize risk differently than ever before. This increased insight into the risk of a loan is balanced by the cost of access and normalization for analysis of the larger amounts of data, but the resulting automated analysis is less susceptible to bias and error.

To balance these competing factors, embodiments disclosed herein allow for a flexible method of “data triage” allowing an institution to first check lower cost data sources for metric data modules and perhaps make an early decision before subsequently checking higher cost sources and their data modules. The early rejections allowed by this initial partial review, with the addition of more costly sources at each stage of review, allows businesses to save $0.35 to $1.00 or more for each credit evaluation. Since lending institutions commonly evaluate thousands of applications each day, the savings provided by a dynamic evaluation of available data sources is immense.

In addition, the variety of analyses performed at each step of the data acquisition and review must be specific not just for each lender, but for each product that the lending institution offers. While the credit review of all loans may begin, for example, with a credit risk score review as the first pass of qualification, a vehicle loan may subsequently include the vehicle title history whereas a home loan may include the review of a flood certification for the property. As one can assume, some credit decisions would require only a few data sources while others may require many different sources. In addition, in some situations or for some loan products, higher risk is tolerated compared to other situations. Thus the evaluation process must be configurable, repeatable, and cost effective.

These and other features and benefits of the present invention will be apparent from the description that follows.

### BRIEF DESCRIPTION OF THE DRAWINGS

For a better understanding of the embodiments of the inventive subject matter, reference may be made to the accompanying drawings in which:

FIG. 1 is a block diagram of an example embodiment of a computer system upon which embodiment's inventive subject matter can execute;

FIG. 2 is an interaction diagram between the various processing steps and data sources according to embodiments;

FIG. 3 is a data flow diagram of one particular method for performing actions in accordance with project creation and funding according to embodiments;

FIG. 4 is a block diagram of a system according to embodiments; and

FIG. 5 is a block diagram of a system according to embodiments.

### DETAILED DESCRIPTION

In the following detailed description of example embodiments, reference is made to the accompanying drawings that form a part hereof, and in which is shown by way of illustration specific example embodiments in which the inventive subject matter may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the example embodiments should correspond to the Figure number in which the item or part is first identified.

The following examples are provided to illustrate the operation of the above described systems and methods. Where applicable, references are made to figures as described. Figure element indicators are used to indicate specific figure elements where numerics 1xx refer to elements from FIG. 1, 2xx refer to elements from FIG. 2, and so on. Where the various examples are presented as an interconnected narrative, the interconnection is not necessary or expected as an aspect of the inventive subject matter. The embodiments may only provide functionality for any single example, or even a related topic obvious to one of ordinary skill in the art, and still provide an experience unique in the art. In the examples below, references to “credit decisions” refer to a system incorporating embodiments of the inventive subject matter.

The description of the various embodiments is to be construed as exemplary only and does not describe every possible instance of the inventive subject matter. Numerous alternatives can be implemented, using combinations of current or future technologies, which would still fall within the scope of the claims. The following detailed description is, therefore, not to be taken in a limiting sense, and the scope of the inventive subject matter is defined only by the appended claims.

For illustrative purposes, various embodiments may be discussed below with reference to a least cost loan decision. The most common example discussed in detail is providing a loan for an automobile purchase. This is only one example of a suitable environment and is not intended to suggest any limitation as to the scope of use or functionality of the inventive subject matter. Neither should it be interpreted as having any dependency or requirement relating to any one or a combination of components illustrated in the example operating environments described herein.

Different embodiments may utilize a hosted decisioning engine or a stand-alone installed software decisioning engine. For illustrative purposes, the most common system used in the discussions is a hosted decisioning engine as it has the most ready access to the variety of data sources. This is only one example of a suitable system and is not intended to suggest any limitation as to the scope of use or functionality of the inventive subject matter. Neither should it be interpreted as having any dependency or requirement relating to any one or a combination of components illustrated in the example operating environments described herein.

In general, various embodiments combine, in a loan decisioning environment, customizable workflow steps distinct for each loan type. Thus some embodiments allow simple decisions with only few data sources analyzed while others may enable complex decisions with numerous data sources analyzed. Each data source utilized may be analyzed alone, in sequence, or in combination with other data sources before the decision process moves to the next data source reliant decision.

Certain embodiments allow a bank to enter a set of credit decision rules specific for the bank's business purpose of creating a loan approval workflow. For example, the bank may interact with a hosted service provided by Zoot Enterprises to construct the following rule set for allowing vehicle loans: If (CREDIT_SCORE>650) AND (VEHICLE_TITLE_INFO.mileage<50000) AND (VEHICLE_TITLE_INFO.accidents=0) AND (DMV_RECORD.valid_license) AND (INSURANCE_RECORD.driver_points<3) THEN (Allow Loan<$20,000) In this example multiple data sources are necessary for the credit decision: (1) credit risk score e.g. FICO or other provider, (2) Vehicle Title information, (3) Department of Motor Vehicles (DMV) information, (4) Insurance information.

In this example the hosted system at Zoot Enterprises is pre-configured to have programmatic query access to each of the four data sources. The hosted system also allows access to the various data providers at negotiated rates specific to each of the various institutions.

In this example, each data source could be checked one at a time. Assume, for instance, that the credit risk score data query costs $0.20, the Vehicle Title information query costs $2.50, the DMV record enquiry costs $1.25, and the insurance information review costs $4.00. If all sources are queried for each credit evaluation the total cost to the bank would be $7.95. If, for comparison, the credit risk score (where higher is better in this case) is less than 650 then the credit decision process can immediately stop and deny credit without checking the other three data sources. In this scenario the bank saves $7.75 by recognizing the credit risk of the individual early. Thus, in this scenario there are four possible cost outcomes depending on where in the evaluation there is sufficient data to make a credit decision: $0.20, $2.70, $3.95, or $7.95.

Of consideration, the likelihood of rejection for each step could be considered during the credit decision rule. In this example, perhaps the bank has found that it is more likely that the vehicles a consumer attempts to buy are more often outside of the loan profile than it is likely that the consumer has an invalid license, the bank may encode a decision to use a higher cost data source earlier in the loan scoring process. Here the bank has chosen to use the Vehicle Title information at $2.50 before the lower cost DMV information at $1.25. It follows that the bank likely considers the credit risk score check to be so inexpensive to always perform first, but next considers the Vehicle Title information because too often they had provided loans with bad repayment history when the vehicle mileage was too high or the vehicle had previously been in accidents. In fact, this was a more common risk scenario for the bank than DMV or Insurance information. So, if the consumer has a good credit score but vehicle in question for the loan application is unacceptable, the bank can stop checking other data sources and deny the loan after incurring only $2.70 in data access costs.

It should be obvious that the data sources could be evaluated in single succession as described so far. However, one could easily combine data source comparisons into a single step. For instance, one could envision a bank encoding the following thought process: “We need to first check the credit risk score to see if we should work with this person. If they are a reasonable risk, then we need to check if the vehicle is a reasonable risk. If both of those things are good, then we will grant the loan unless there is something unusual.” This business process could result in the following rule: If (CREDIT_SCORE>650) AND (VEHICLE_TITLE_INFO.mileage<50000) AND (VEHICLE_TITLE_INFO.accidents=0) AND [(DMV_RECORD.valid_license) AND (INSURANCE_RECORD.driver_points<3)] THEN (Allow Loan<$20,000) where the DMV and Insurance data sources are always performed in conjunction. In other words, the first test on credit risk is a gate on the individual, the second test on the Vehicle Title is a gate on the collateral. Each must pass in succession. The last two tests are simply done as a matter of making sure the bank has covered all their bases and will always do both tests if the evaluation reaches this point. In this scenario the bank will incur one of: $0.20, $2.70, or $7.95 depending on which test concludes the analysis.

Turning now to the figures, we shall see how the embodiments are further described with reference to various diagrams and flow charts.

FIG. 1

FIG. 1 is a block diagram of an example embodiment of a computer system 100 upon which embodiment's inventive subject matter can execute. The description of FIG. 1 is intended to provide a brief, general description of suitable computer hardware and a suitable computing environment in conjunction with which the embodiments may be implemented. In some embodiments, the embodiments are described in the general context of computer-executable instructions, such as program modules, being executed by a computer. Generally, program modules include routines, programs, objects, components, data structures, etc., that perform particular tasks or implement particular abstract data types.

The system as disclosed herein can be spread across many physical hosts. Therefore, many systems and sub-systems of FIG. 1 can be involved in implementing the inventive subject matter disclosed herein.

Moreover, those skilled in the art will appreciate that the embodiments may be practiced with other computer system configurations, including hand-held devices, multiprocessor systems, microprocessor-based or programmable consumer electronics, network PCs, minicomputers, mainframe computers, and the like. The embodiments may also be practiced in distributed computer environments where tasks are performed by I/O remote processing devices that are linked through a communications network. In a distributed computing environment, program modules may be located in both local and remote memory storage devices.

In the embodiment shown in FIG. 1, a hardware and operating environment is provided that is applicable to both servers and/or remote clients.

With reference to FIG. 1, an example embodiment extends to a machine in the example form of a computer system 100 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 100 may include a processor 102 (e.g., a central processing unit (CPU), a graphics processing unit (GPU) or both), a main memory 106 and a static memory 110, which communicate with each other via a bus 116. The computer system 100 may further include a video display unit 118 (e.g., a liquid crystal display (LCD) or a cathode ray tube (CRT)). In example embodiments, the computer system 100 also includes one or more of an alpha-numeric input device 120 (e.g., a keyboard), a user interface (UI) navigation device or cursor control device 122 (e.g., a mouse, a touch screen), a disk drive unit 124, a signal generation device (e.g., a speaker), and a network interface device 112.

The disk drive unit 124 includes a machine-readable medium 126 on which is stored one or more sets of instructions 128 and data structures (e.g., software instructions) embodying or used by any one or more of the methodologies or functions described herein. The instructions 128 may also reside, completely or at least partially, within the main memory 108 or within the processor 104 during execution thereof by the computer system 100, the main memory 106 and the processor 102 also constituting machine-readable media.

While the machine-readable medium 126 is shown in an example embodiment to be a single medium, the term “machine-readable medium” may include a single medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information for a period of time, however brief Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 128 may further be transmitted or received over a communications network 114 using a transmission medium via the network interface device 112 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, wireless data networks (e.g., WiFi and WiMax networks), as well as any proprietary electronic communications systems that might be used. The term “transmission medium” shall be taken to include any intangible medium that is capable of storing, encoding, or carrying instructions for execution by the machine, and includes digital or analog communications signals or other intangible medium to facilitate communication of such software.

The example computer system 100, in the preferred embodiment, includes operation of the entire system on a remote server with interactions occurring from individual connections over the network 114 to handle user input as an internet application.

FIG. 2

Referring now to FIG. 2, one example embodiment of the present disclosure may comprise an architectural design 200 for relating the client interface 202 with the decisioning engine 204 and the data sources 206. In this embodiment the client interface 202 represents both the configuration interface for the financial institution to encode their business rules as well as the credit query interface for the evaluation of an individual's credit risk. Similarly, the decisioning engine 204 represents the processing environment for both the encoded business rules for a financial institution as well as the processing location for the evaluation of the business rules. The data sources 206 represents the variety of data sources that the decisioning engine 204 may query. The data sources 206 may reside on the same location as the decisioning engine 204 or external to the decisioning engine 204 and must therefore be queried from their respective locations independently. Any combination of co-storage with the decisioning engine 204 and external locations may be expected as various embodiments. One or more data sources 206 is used for evaluating the business rules encoded in the decisioning engine 204.

The variety of data sources 206 may include demographic database searches 208 to access basic demographic information, title/flood information 210 to access property-specific information, closing & booking information 212 to access information about the status of accounts, automated property valuation services 214 to determine property values, business bureaus 216 to access business credit information, consumer bureaus 218 to access consumer credit information, red flag information 220 to access identity theft information, decisioning services 222 to access external decisioning services not included in the decisioning engine 204, fraud databases 224, loan documentation databases 226, OFAC & Patriot Act information 228 to determine locked assets or restricted individuals, appraisal information 230 to determine property specific values, alternative data sources 232 and other current and future data sources 234.

FIG. 3

Referring now to FIG. 3, one example embodiment of the present disclosure may comprise the least cost data acquisition flow 300. In the example data flow of the system 200, a decision request 302 is received from the client interface 202. The decision request 302 causes the decision engine 204 to evaluate the customer data 304. Upon the first step of evaluating the customer data 304, a determination of which data to use 306 is made and a vendor request 308 is made via a vendor integration service. The vendor system 206 evaluated the vendor request 310 and composes a response 312 which is sent back 314 via the vendor integration service. Upon receipt in the decision engine 204, the data response is evaluated, business logic executed and additional requests are made if necessary 316. The request, response, evaluation cycle is repeated as needed 318-336 to complete all necessary data requirements before assigning the appropriate products 338 and returning a decision response 340 back to the client interface 202.

While multiple paths are shown between the hosted decision engine, vendor integration service, and vendor, if only one request satisfies the credit decision 316, additional requests are not performed; if more requests are needed than shown the same process repeats until all data needs are satisfied. In addition, while a single category is used to indicate the vendor integration service and the vendor, each vendor and integration service could be unique for each query. Further, the integration service may include a simple pass through or a formal integration. Finally, in some embodiments the vendor data exists on the hosted decision engine and no integration service or external calls are needed to access the local vendor data.

FIG. 4

Referring now to FIG. 4, one example embodiment of the present disclosure may comprise a detailed architectural design 400. In some embodiments a design tools component 402 exists to allow the construction of the various credit business rules. One potential design tool is the WebRules design time decision logic and workflow configuration tool 404, a tool allowing a business user to create the business workflow rules for credit decisions. Another potential design tool is the Web Automated Install (AI) real time instant rules tool 406, allowing for the creation or modification of existing rules during the execution of those rules. Another potential design tool is the Diakon test file modification tool 408, a tool to normalize and make test cases from vendor data (U.S. Pat. No. 8,239,757, included by reference in its entirety herein).

Continuing with FIG. 4, Client input channels 410 provide an interface for interaction and querying of the various credit rules. Client input could come from bank branches 412, call centers 414, or World Wide Web interfaces 416. Clearly other variations of input channel could be supported as variations, such as direct calls instead of via a call center 414, client server interactions instead of World Wide Web interactions 416, and other localized direct interactions rather than through fixed channels into bank branches 412. Once a set of decision rules and a credit query against those rules, the single point of contact (SPOC) Decision Engine 418 is engaged. The SPOC is designed to provide a single, consistent access point for all decisioning, preventing inconsistent responses based upon incoming channel. Within the SPOC Decision Engine, one or more of the following functions is occurs: workflow processing 420 of the credit information is performed, attributes of the credit data 422 are processed, custom scoring 424 of the data is performed as needed, data and data acquisition rules are executed 428, credit policy rules 430 are executed, fraud policy rules 432 are executed, or product bundling/packaging rules 434 are executed to combine credit services when appropriate.

Continuing with FIG. 4, certain portions of the decision engine 418 such as, but not limited to, the data and data acquisition rules 428 and the fraud policy rules 430 interact with external data sources 438 through the data acquisition, vendor network, and vendor integration services 436 as shown earlier in 300. External data sources 438 could include common sources such as Equifax 440, Experion 442, Trans Union 444, Lexis Nexis 446, Acxiom 448, and any number of other sources 450, 452.

Continuing with FIG. 4, the decision engine 418 also provides several common business functions 454 such as: Analytics/Client Outputs 456 to display system performance and execution information analytics, Letter Fulfillment Output 458 to generate credit correspondence, Processing Systems 460 to integrate to other business units, and Booking/Servicing extract capabilities 462 which may occur in either real time or batch mode.

FIG. 5

Referring now to FIG. 5, one example embodiment of the present disclosure may comprise a system as shown in FIG. 5. First, a request from an interested party is received at Receive Request 500 and is validated in the validation step 510. The information received by the Receive Request 500 is from a financial institution with consumer information. The validation step 510 determines if there is enough data to move forward with the application. If the request or data is not valid, then it is sent to the send response box 560, which alerts the interested party that it is an invalid request. If the request or data is valid, then the system will determine if the applicant needs an authentication product in step 512. An authentication product determines if the system already knows the applicant or if the identity of the applicant needs confirmation.

If the applicant needs an authentication product, then the relationship is reviewed in step 514. The system reviews any information obtained from the financial institution about any accounts that the applicant may have. The system reviews the relationship between the applicant and the financial institution, including how many products the applicant has purchased, age, and other information that aids the analysis of the relationship and any potential risk of fraud.

In step 516 the applicant is rated based on the information gathered in the relationship review step 514 providing the applicant with a high or low value type of customer rate. If a more comprehensive product is required, then a higher priced authentication product and a more expensive validation product is pulled in step 518. If a less comprehensive product is required, then a lower priced authentication product is pulled in step 520. Examples of authentication products are Lexus/Nexus, IDA or Equifax.

Output from steps 518, 520 goes into the pass authentication box 522. The output from steps 518, 520 is typically a score that is checked against making sure that the applicant was authenticated. If the answer is yes, then the application moves to box 524 to determine if the applicant needs a compliance product. If the answer to step 512 is no then the application also moves to box 524 to determine if the applicant needs a compliance product. If the applicant needs a compliance product, then the system reviews the relationship and application data in step 526. In step 526, the system reviews what channel this particular application may have come from, takes a look at what kind of a relationship the financial institution already has with the applicant and determines how vigilant of a compliance product the system will pull. If the answer is yes in step 526, then a determination is made in step 528 as to whether a more comprehensive product is required. If a more comprehensive product is required, then a higher priced compliance product and a more expensive compliance product is pulled in step 530. If a less comprehensive product is required, then a lower priced compliance product is pulled in step 532.

Output from steps 530,532 goes into the pass compliance box 534. If the answer is yes, then the application moves to box 536 to determine if the applicant needs a fraud product. If the answer to step 524 is no then the application also moves to box 536 to determine if the applicant needs a fraud product. A fraud product checks things like velocity (i.e. checking if a social security number is associated with fraud in the past) and if the address is known. There are fraud companies that track fraud related to addresses on a fraud list and also are looking to determine whether or not fraudsters exist. In addition, if the application came into the system over the Internet, then it is more likely that a fraud product will be pulled.

If the applicant needs a fraud product, then the system reviews the relationship and application data in step 538. If the answer is yes in step 538, then a determination is made in step 542 as to whether a more comprehensive product is required. If a more comprehensive product is required, then a higher priced fraud product and a more expensive fraud product is pulled in step 544. If a less comprehensive product is required, then a lower priced fraud product is pulled in step 546.

Output from steps 544, 546 goes into the pass fraud box 548. If the answer is yes, then the application moves to box 540 to determine if the applicant needs a credit product. If the answer to step 536 is no then the application also moves to box 540 to determine if the applicant needs a credit product. The process in box 548 is to review a fraud score that is evaluated based upon a financial institution criterion and determines whether or not the applicant passed fraud.

If that answer is yes then the applicant moves to the step of reviewing the relationship and application data in step 550. If the answer is yes in step 550, then a determination is made in step 552 as to whether an alternative data provider should be used. In step 552, it is determined whether or not the applicant is more likely to get data from an alternative data provider such as Lexus/Nexus based upon how old the applicant might be, how long the applicant has been in certain jobs, how long the applicant has been in a house, and similar informational items. If the answer is yes, then alternative credit data in 554 and if no, the traditional credit is pulled in step 556. The application is moved to the pass credit box 558. If it passes, then an offer is extended and if it fails then the applicant is declined.

If “no” responses come from boxes 510, 522, 534, 548, and 558, then a Send Response box 560 provides an answer to the applicant. If any of these steps provide a “no” answer, then the application process is stopped and money is saved from having pull the more expensive reports. The order in which these different products is checked from the least expensive to most expensive report.

### EXAMPLES

The following examples will help clarify the various figures and detailed descriptions. Each example represents a potential embodiment, but does not limit the scope of the present disclosure. To provide a measure of consistency amongst the examples for sake of simplicity of understanding, the following arbitrary costs are associated with each of the various data sources shown in FIG. 2 206:

| Demographic | | | Automated | | | |
|---|---|---|---|---|---|---|
| Database | Title/ | Closing & | Property | Business | Consumer | |
| Searches | Flood | Booking | Valuation | Bureaus | Bureaus | Red Flag |
| $0.25 | $3.00 | $8.00 | $0.50 | $1.25 | $0.20 | $0.15 |

| Decisioning | | Loan | OFAC & | | Alternative |
|---|---|---|---|---|---|
| Services | Fraud | Documentation | Patriot Act | Appraisal | Data |
| $0.80 | $0.75 | $3.00 | $0.95 | $7.50 | specified |
| | | | | | per example |

### Example 1

### Business Line of Credit

Doug is the owner of Underground Gear, LLC. Underground Gear offers lights and equipment for caving and outdoor activities. Doug started the business with some of his own capital and launched with reasonable success. He has found a unique niche and has loyal customers after only 6 months in business. Recently Doug has an opportunity to be the exclusive worldwide distributor of a high end piece of technical equipment that would solidify his role in the industry. However, he must commit to a large purchase of the equipment to both support his expected customer demand as well as solidify the distributor agreement. To purchase the appropriate amount of inventory Doug must order $20,000 worth of the equipment. His profit margin on the sale of the items will be 100%, meaning that he can sell the $20,000 worth of inventory for $40,000, and he is optimistic he can clear that inventory in around 4 months. Unfortunately he does not have the $20,000 and approaches CommunityLocal Bank for a $15,000 business line of credit to help with this inventory purchase.

CommunityLocal takes the Underground Gear loan application and uses a hosted credit verification service to determine if they should underwrite the loan. For a business line of credit loan, the rules that CommunityLocal has entered into the credit verification service are as follows: IF (LOAN.amount<$50,000) AND (BUSINESS_BUREAU.status>=GOOD) AND [(FRAUD=NONE) AND (OFAC & PATRIOT ACT=NONE)] AND (APPRAISAL>=90% of amount) AND (CLOSING & BOOKING=20% of amount) THEN APPROVE. When the rule executes it uses the following data sources in order: Business Bureau ($1.25), Fraud AND OFAC & Patriot Act ($0.75+$0.95=$1.70), Appriasal ($7.50), Closing and Booking ($8.00). In this example, Underground Gear has a good business rating so the next data sources are checked. Underground Gear passes the fraud and Patriot Act checks, so the next data source is checked. The appraisal comes out low, so credit is denied at this gate. CommunityLocal thus spent $1.25+$1.70+$7.50, but did not need to spend the $8.00 to check the last data service, and thus saved $8.00 by ending the decision before using the final and most expensive data source.

### Example 2

### Personal Credit Card

BigBank Visa wants to offer a credit card to consumers that fit a certain profile. To do this they purchase a database of 1,000,000 consumers and need to evaluate each consumer on the list to determine if that individual should receive a credit card offer in the mail. They create a credit decision rule set to define individuals who would be a good match for this credit card as follows: IF (CREDIT.score>=575) AND [(RED_FLAG=NONE) and (FRAUD=NONE)] AND [(DEMOGRAPHIC.location=WESTERN_US) and (DEMOGRAPHIC.age=25-55)] AND (EMPLOYMENT.status=CURRENTLY_EMPLOYED) THEN Send Offer

BigBank expects that the credit risk score should be the first filter, but they also want to make sure that the individuals they are marketing to are real people. Next they want to target certain ages and locations, and if all goes well then they do a final test on the employment status. All of the databases are standard except the employment database which they have negotiated access to for $1.00 per query. What BigBank discovers is that 70% of people pass the first test on credit risk score, 95% pass the second tests on fraud, 50% pass the demographic tests, and 80% pass the employment test. A traditional approach for data source evaluation would cost $0.20+($0.75+$0.15)+$0.25+$1.00 for a total of $2.35 for each of the 1,000,000 people in the list, with an expected success rate for matches of 70%*95%*50%*80%=26.6%. Thus, in the traditional approach they would spend $2,350,000 for 266,000 applications. However, since they are using a least cost data acquisition model to only use new data sources for those people that pass the previous data source test, they pay (1,000,000*$0.20)+(70%*1,000,000*$0.90)+(70%*95%*1,000,000*$0.25)+(70%*95%*50%*1,000,000*$1.00) or $200,000+$630,000+$166,250+$356,250 for a total of $1,352,500, and a savings of $997,500!

BigBank recognizes there may be better savings if they optimize their rules. They recognize there is a large drop in matches on demographic information, so they adjust their approach to eliminate the most people first and only do the tests they expect the majority of people to pass at the end. They recreate the rule set to be: IF [(DEMOGRAPHIC.location=WESTERN_US) and (DEMOGRAPHIC.age=25-55)] AND (CREDIT.score>=575) AND (EMPLOYMENT.status=CURRENTLY_EMPLOYED) AND [(RED_FLAG=NONE) and (FRAUD=NONE)] THEN Send Offer and end up with the following expected expense: (1,000,000*$0.25)+(50%*1,000,000*$0.20)+(50%*70%*1,000,000*$1.00)*(50%*70%*80%*1,000,000*$0.90) or $250,000+$100,000+$350,000+$252,000 for a total of $952,000 or $0.952 per individual! This new model is a savings of $400,500 over the earlier least cost data acquisition approach and an amazing $1,398,000 savings, or nearly 60% over the traditional approach. The bank happily uses this new model in conjunction with the least cost data acquisition approach and optimizes their marketing campaign at a much lower cost than they had traditionally been able to do.

### Example 3

### Personal Mortgage

Bob and Sue Allard have decided that after being married for 2 years they are in a stable enough situation to buy their first house. After reviewing the housing market for several months they find a house they like. While they have worked out with their mortgage broker that their estimated mortgage amount could be $200,000, the current house they have made an offer on is $180,000. The mortgage approval process now begins according to the lender's rules: IF (average(CREDIT.score)>720) AND (AUTOMATED_VALUATION.property>=Amount) AND [(each(DEMOGRAPHIC.age)=25-35) AND (total(DEMOGRAPHIC.income_range)>$65,000)] AND (RED_FLAG=NONE) AND (FRAUD=NONE) AND (PATRIOT_ACT=NONE) AND [(LOAN_DOC.debt_ratio<0.4) AND (LOAN_DOC.primary_residence=TRUE)] AND [(FLOOD.risk=LOW) AND (TITLE.encomberances=CLEAR)] THEN Approve

Assuming that the Allards make it through the full credit approval process, the cost incurred to their mortgage institution is: $0.20+$0.50+$0.25+$0.15+$0.75+$0.95+$3.00+$3.00 or $8.80, but since the mortgage institution has configured their system to check each data source in sequence, the mortgage institution expects their costs to be much lower on average. As it turns out, while their credit risk scores of 715 and 762 exceed the initial test, the Allards have made an offer on a house that is above the automated property valuation and the loan is denied after checking only two data sources, charging the mortgage institution only $0.20+$0.50 or $0.70, saving them $8.10 in processing fees for a loan that they would not issue.

### Example 4

### Vehicle Loan

Leif would like to purchase a new vehicle to replace his aging Subaru. After some checking, he decides instead to purchase a used Toyota Prius. He finds one with only 42,000 miles and at a reasonable price of $16,000. He checks with CommunityLocal Bank for a loan, and they use their automated credit evaluation system with the following least cost data rule: IF (CREDIT.score>600) AND (DEMOGRAPHIC.metro_theft_rate=LOW) AND (AUTOMATED_VALUATION.bluebook>=Amount) AND (TITLE.accident_status=NONE) AND [(RED_FLAG=NONE) AND (FRAUD=NONE) AND (PATRIOT_ACT=NONE)] AND (LOAN_DOCUMENTATION.income>$50,000) THEN Approve

In this scenario, CommunityLocal's evaluation would cost $0.20+$0.25+$0.50+$3.00+($0.15+$0.75+$0.95) or $5.80. Since they are using least cost data acquisition methods where the expected gating for each test reduces their overall costs by rejecting unqualified people sooner, they expect their costs to average closer to $4.00. In Leif's case, he has superb credit (risk score of 782) and lives in the very low theft state of Montana. In addition, the price he has found for the Prius is $467 below BlueBook value for that year and mileage. Luckily for Leif, the title check indicates that the Prius he is looking at has previously been in a severe accident, and the loan is denied. Leif is thankful that this data has been discovered on the car he was about to purchase and CommunityLocal is happy that they only incurred $0.20+$0.25+$0.50+$3.00 or $3.95 instead of the full amount of cost for checking all data sources.

### Example 5

### Large Purchase Qualification

David is quite wealthy from selling his company recently and he wants to use some of his new wealth to purchase some decorative but investment quality artwork. So, David registers for an upcoming Sotheby's auction. Part of the Sotheby bidder qualification process includes a detailed credit check to determine if the individual is able to follow through on the bids they make, and similarly to restrict their access to only those auctions with expected sale prices within the financial means of the bidder. Thus Sotheby's has started using a hosted credit checking service which uses a least cost data acquisition approach for evaluating a variety of data sources. Sotheby's has created several evaluation criteria for each of its auction tiers, and David has applied for the highest tier which is supported by the following rule: IF (CREDIT.score>800) AND (RED_FLAG=NONE) AND (FRAUD=NONE) AND (PATRIOT_ACT=NONE) AND (NET_WORTH.liquid>$3,000,000) AND (ART_DECISION_SERVICE>=ACCEPTABLE) THEN Accept. Sotheby's has configured their decisioning system to use two alternate sources, the NetWorth database interfaces with banks and brokerage houses to report on the financial holdings of an individual and costs $10.00 to access. The Art Decision service is a decision service used by insurance companies to evaluate individuals for their art infrastructure, things such as security systems, controlled temperature and humidity environments, and other criteria found by art insurers to be necessary for an individual to properly protect expensive art objects.

Sotheby's would incur a cost of $0.20+$0.15+$0.75+$0.95+$10.00+$0.80 or $12.85 per qualification process. David passes all the tests except the final Art Decision service—he simply does not have an environment that is set up for expensive art even though he can afford it. Sotheby's incurs a charge of $12.85 but does not allow David to bid on the art he would like. Upon review, Sotheby's realizes that the Art Decision service test could be moved earlier in the process since most people who pass that test also pass the net worth and various fraud tests. They restructure their evaluation rules to be: IF (CREDIT.score>800) AND (ART_DECISION_SERVICE>=ACCEPTABLE) AND (RED_FLAG=NONE) AND (FRAUD=NONE) AND (PATRIOT_ACT=NONE) AND (NET_WORTH.liquid>$3,000,000) THEN Accept. This change in data source review order saves $0.15+$0.75+$0.95+$10.00 or $11.85 for most of the applications they receive since the Art Decision service filtered 85% of their applicants who passed the initial credit score test.

### Example 6

### Quick Decisions

Community Local has noticed that every loan request that goes out to individuals with a credit risk score greater than 800 is always paid back in full, no matter whether the other conditions of the loan are met. They re-evaluate their vehicle loan rule set (from Example 4) to: IF (CREDIT.score>800) OR [(CREDIT.score>600) AND (DEMOGRAPHIC.metro_theft_rate=LOW) AND (AUTOMATED_VALUATION.bluebook>=Amount) AND (TITLE.accident_status=NONE) AND [(RED_FLAG=NONE) AND (FRAUD=NONE) AND (PATRIOT_ACT=NONE)] AND (LOAN_DOCUMENTATION.income>$50,000)] THEN Approve. Now they quickly grant the loan to every applicant with a high credit risk score, saving costs by not evaluating data sources that are not needed.

### Example 7

### Balance Business Tradeoffs

Community Local bank has had to react to a number of challenging business situations due to external financial events. As a small financial institution, often their business is susceptible to even small changes in clientele and circumstance. For example, they have tight margins on their loan operation pertaining to the charges for access to risk evaluation data sources. When they review their current loan process they discover that they are bleeding money on the loan application process and they need to adjust their costs. They may decide to loosen their loan risk guidelines to avoid the increased fees associated with their more stringent risk analysis. Similarly, they could see an opportunity to expand their business due to a change in the local business community. To quickly expand their client list they could permit greater acceptance of applications. Thus, within the accessible framework of defining decisioning rules they can quickly balance the risk versus cost versus acceptance criteria for each loan. The decisioning logic is simple and exposed to the business to change as they see fit.

### Example 8

### Testing

Sometimes banks are not sure whether one risk evaluation approach is better than another approach to meet their current goals. Thus, when CommunityLocal decides they need to optimize their cost reduction process without impacting the risk profiles of those granted credit, they can use a testing paradigm to determine whether an alternative approach works better. To do this testing they can select, say, 10% of their applicants at random to use the hypothetical lower cost evaluation rule for three months. At the end of this three month period they can analyze the specific loans approved in each case to determine how similar the resulting risk profile turned out to be. CommunityLocal can then see whether the alternative approach cost less money per evaluation and if the approved and rejected loan applications maintained a consistent risk profile. CommunityLocal has used this testing approach several different times as their business balances have changed over time from cost sensitivity to client acquisition to changing risk tolerances and it allowed them to change their business in the most cost effective and lowest risk way, allowing them to be even more profitable as a business.

### Example 9

### Government Regulations

Due to a recent law passed by Congress, all financial institutions are now required to validate income sources and estimate future income when determining whether or not to grant a mortgage. Unfortunately, the income validation and estimation data sources are the most expensive sources. Using the credit decisioning logic allowing least cost data source considerations, BigBank is able to place the income validation and estimation checks at the end of the evaluation logic; thus only those applications which have passed all other qualifications are subjected to the most costly tests now required by the government regulations. Their competitor, TopNational Bank, does not use a system focused on minimizing the data analysis costs and are at a competitive disadvantage to BigBank because all mortgage applications now incur the income test charges and TopNational Bank can't afford to process as many applications.

### Example 10

### Temporal Advantage

Similar to the previous example, when a new law is passed by Congress to require the validation of income sources, the first banks to adapt to that regulatory change gain a significant advantage over their competitors. Thus, BigBank, using the Least Cost Data Acquisition approach can not only incorporate the new income checks more cheaply in their evaluation process as previously described, the fact that they can quickly and efficiently modify their decision engine to collect and utilize this information allows them to continue to provide mortgage evaluations while TopNational must delay accepting any mortgage applications until they have incorporated the data evaluations now required by law.

### Example 11

### New Data Sources

TrendyBank wants to stay on top of the emerging technology trends. This focus provides a specific clientele that appreciate the modern approaches. For example, they pride themselves that they were one of the first banks to have a robust, online banking option. One emerging trend they have discovered is the availability of a new data source they can use as part of their credit evaluation process. They have discovered that there exists a Social Presence Score that they can use to cut down on the incidence of fake credit applications. The Social Presence Score collects the number, variety, and activity of online sources associated with the individual applying for credit. Those with a medium or high Social Presence are likely “real” people, while those with a low score are likely artificial personas. Because this data source is so new and also because it is quite easy for the providing company to generate, the cost for the Social Presence Score is quite low. TrendyBank adds it to the credit decision logic early in the evaluation process to help filter out bogus credit applications since it is cheaper than doing other identity check services.

### Example 12

### Emerging Real Time Data Sources

Similar to how TrendyBank was able to quickly include an entirely new data source in their credit scoring process is the recognition that a Single Point Of Contact Decision Engine has access to all new data sources as they become available. Even in the 21^{st} century there remain a number of risk evaluation sources that are not automated and rely, for example, on paper records. Many of these sources have initiatives to make them available electronically, and as those sources are digitized they change from being an off-line or asynchronous check in the risk evaluation process to being part of a real time evaluation data source that can be added and used by any company using a least cost data acquisition system.

The examples provided above are not intended to be an exhaustive explanation of each possible operation of the systems and methods described herein, and the various embodiments are not limited to any example described above.

Although an overview of the inventive subject matter has been described with reference to specific example embodiments, various modifications and changes may be made to these embodiments without departing from the broader spirit and scope of inventive subject matter. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

1. A hosted computing system for credit decisioning comprising:
one or more processors configured to receive financial applications;
the processors further configured to acquire data from a plurality of repositories of credit histories, said credit histories corresponding to the credit risk associated with persons making said financial applications, said repositories having a cost range in using said data from low to relatively high values; and
said processors further configured to identify the financial risk to persons using said data from said repositories, the processors being further configured to select a least cost risk module and said processors being configured to enable said person to make a financial decision without having to check a relatively higher cost value module.

2. A hosted computer implemented a method for credit decisioning, said method comprising the steps of:
receiving loan applications at one or more computing device;
storing data modules in said computing devices from a plurality of repositories of credit histories, said data modules corresponding to credit risk to persons making loan applications to a lending institution, said repositories having data modules being usable in evaluating the risk of making a loan and having a cost range in using said data modules from low to relatively higher cost values; and
identifying credit risks applicable to said loan applications using said stored repository data and selecting a least cost data module in the credit decisioning process.

3. The method as in claim 2, wherein the selecting step is made without having to consider using from relatively higher cost values of said data.

4. The method as in claim 2, wherein said selecting step results in the selection of the least cost credit risk resulting in a loan denial.

5. The method as in claim 2, wherein a lending institution receives said loan application, said lending institution having a plurality of loan products that are available to qualified loan applicants, said method including the step of matching credit decisioning related to said application with one of said loan products at the least cost to the lending institution.

6. The method as in claim 5, wherein one or more of said loan products include customizable workflow steps in order to access same.

7. The method as in claim 2, including the step of analyzing each repository of data as one of alone, in sequence, and in combination.

8. The method as in claim 7, wherein there are a plurality of data source reliant decisions, and including the step moving to the next data source reliant decision at the completion of said analyzing step.

9. The method as in claim 2, wherein said repositories of credit information include one of Experian, TransUnion and Equifax.

10. The method as in claim 2, wherein at least one metric corresponds to credit risk, and wherein said at least metric is a FICO score.

11. The system as in claim 1, wherein said financial applications are loan or credit applications, and wherein persons are institutions that lend money or approve credit.

12. The system as in claim 11, including means for enabling said lender to make a loan decision without having to consider higher cost value data modules.

13. The system as in claim 11, including means for enabling the lender to select a least cost data module resulting in a loan denial.

14. The system as in claim 11, wherein said lending institution has a plurality of loan products that are available to quick feed loan applicants including means for matching credit decisioning related to said loan application with one of said loan products at the least cost to the lending institution.

15. The system as in claim 14, including means for customizing work flow steps in order to access said one of said matched loan products.

16. The system as in claim 11, including means for analyzing data from each said repository as one of alone, in sequence, and in combination.

17. The system as in claim 16, wherein including a plurality of data source reliant decisions, and means for moving to the next sequential data reliant decision at the completion of said analyzing step.

18. The system as in claim 11, wherein said repositories of credit information in one of Experian, TransUnion and Equifax.

19. The system as in claim 11, including means for using a FICO score as at least one metric to make said loan decision.
